(19) United States
(12) Patent Application Publication
(10) Pub. No.: US 2004/0112717 A1
(43) Pub. Date: Jun. 17, 2004

(54) Loading fork and sweep conveyor

(76) Inventor: Richard Archer Melville, Auckland (NZ)

Correspondence Address: Patrick D Richards, McDermott Will & Emery, 227 West Monroe Street, Chicago, IL, 60606-5096, US

(21) Appl. No.: 10/250,865

(22) PCT Filed: Dec. 24, 2001
(86) PCT No.: PCT/NZ01/00297

(30) Foreign Application Priority Data
Jan. 3, 2001 (NZ) 509253

(51) Int. Cl. B65G 17/34; B65G 47/34; B65G 47/18

(52) U.S. Cl. 198/539; 198/562

(57) ABSTRACT

The present invention discloses a loading fork (10) and a system for smoothly transferring an object between the loading fork (10) and an infeed or take-away conveyor (110). The loading fork (10) may include a plurality of fingers (12, 14, 16, 18 & 20) mounted above a carriage (22) that is coupled to a chain conveyor (100). The conveyor (110) may be a plurality of parallel aligned narrow belts (102) between which the fingers (12, 14, 16, 18 & 20) of the loading fork (10) may pass to ensure a smooth transfer of the object between the loading fork (10) and the infeed or take-away conveyor (110). The present invention also discloses a sweeping conveyor (136, FIG. 3) for assisting the transfer of an object from the loading fork (10) to the take-away conveyor (110).

### BACKGROUND OF THE INVENTION

1. Field of Invention

The present invention relates to a loading fork used for transferring cuts of meat from station to station in a meat packing plant and simultaneously placing the cuts of meat in bags through a bagging operation. Specifically, the present invention relates to a loading fork capable of providing a bagging operator the ability to bag cuts of meat without lifting or otherwise handling the cuts. Further, the loading fork is capable of smoothly transferring bagged cuts to a take-away conveyor, thereby eliminating the need for manual repositioning and smoothing of the bagged cut of meat on the take-away conveyor and reducing the number of bags damaged in the transfer process. Moreover, the present invention includes a sweep conveyor for pushing the bagged cut of meat from the loading fork onto the take-away conveyor.

2. Background Art

Meat packing operations have traditionally employed standard belt conveyors as a means of transporting cuts of meat between meat packing operations. For example, a standard belt conveyor can be used to transport cuts of meat to a bagging operation where an operator pulls an appropriately sized bag over each cut of meat. After the bagging operation, the cut of meat can be transferred to the next standard belt conveyor for transfer to a vacuum packing operation.

One limitation of standard belt conveyors is there is no control mechanism for providing consistent spacing between cuts of meat unless the conveyor is cleated or segmented. Moreover, it is difficult for a bagging operator to perform the bagging operation properly and efficiently without controlled spacing between cuts of meat without the cut being transferred to a separate loading device.

Recently, in response to the limitations of standard belt conveyors, some meat packing operations have begun to employ loading fork conveyors rather than standard belt conveyors in the bagging operation. A loading fork conveyor consists of a number of loading forks mounted at regular intervals on a conveyor chain or belt. Loading fork conveyors provide an advantage over standard conveyor belts in that the cuts of meat are transferred at a specific separation interval, allowing for controlled synchronization of operations. Additionally, the use of a loading fork conveyor allows an operator in the bagging operation to bag the cut of meat without lifting or touching the cut of meat.

However, loading fork conveyors present problems for transferring cuts of meat from the bagging operation to the take-away conveyor. Generally, a bagged cut of meat is transferred from a loading fork to a take-away conveyor by having the bagged cut fall from the loading fork as the loading fork travels around the horizontal axis of a vertical chain sprocket wheel. In the transfer process, the bagged cut falls the distance between the two conveyors. This distance must include at least a distance of generally approximately three to five feet to provide clearance for the rotating loading fork. The drop distance is necessary because there must be enough clearance between the loading fork and the take-away conveyor to allow the loading fork to pass through the vertical position and continue underneath the loading fork conveyor without contacting the take-away conveyor.

Several problems result from the transfer of bagged cuts from the loading fork to the take-away conveyor. For example, after the bagged cut lands on the take-away conveyor it must be manually repositioned in the bag before entering the vacuum packing operation. Additionally, an operator at the take-away conveyor must manually smooth the tail of the bag to ensure the seal bar of the vacuum packer can function properly.

Furthermore, “bone-in” cuts of meat must be handled separately. The loading fork conveyor is a better transporter of “bone-in” cuts because the cuts sit on the fork itself not the bag as they do in standard belt conveyors. However, the impact caused by the drop from the loading fork to the take-away conveyor often causes the bone to puncture the bag. It is not unusual for the operation to damage twenty-five percent or more of the costlier “bone guard bags.”

Accordingly, it would be desirable to employ a loading fork in a meat packing operation capable of controlling the spacing between cuts of meat and providing the bagging operator the ability to bag cuts of meat without lifting or otherwise handling the cuts, while at the same time being capable of smoothly transferring bagged or unbagged cuts to or from a belt conveyor.

### SUMMARY OF THE INVENTION

It is one of the principal objects of the present invention to provide an improved loading fork that can be used with current fork loading systems.

It is another object of the invention to provide a loading fork that can smoothly transfer a cut of meat from one conveyor to another in such a manner that the meat is in good condition to be taken to the next workstation.

It is still further an object of the invention to provide a loading fork that can be used to bag a cut of meat that is being transferred from one conveyor to another.

It is yet another object of the present invention to provide a sweeping conveyor to assist the transfer of a bagged cut of meat from a loading fork to a take-away conveyor.

These and other objects of the present invention will become apparent upon examining the drawings and figures together with the accompanying written description thereof.

The above objects are to be read disjunctively with the object of at least providing a useful alternative.

### BRIEF DESCRIPTION OF THE DRAWINGS

The present invention will hereafter described by way of example with reference to the following drawings:

FIG. 1 is a perspective view of a lift off loading fork.

FIG. 2 is a perspective view of a loading fork conveyor with the loading fork shown in FIG. 1 and a take-away conveyor.

FIG. 3 is a side view of a loading fork conveyor with the loading fork shown in FIG. 1, an in-line belt conveyor scale, and a take-away conveyor.

FIG. 4 is a perspective view of a sweeping pusher located above a loading fork conveyor with a loading fork and a take-away conveyor.

Unless the context clearly requires otherwise, throughout the description and the claims, the words “comprise”, “comprising”, and the like are to be construed in an inclusive sense as opposed to an exclusive or exhaustive sense, that is to say, in the sense of “including”, but not limited to.

### DETAILED DESCRIPTION OF THE DRAWINGS

The present invention relates to a loading fork used for transferring meat from station to station in a meat packing plant and simultaneously placing the meat in bags through a bagging operation. Specifically, the present invention relates to a loading fork capable of providing a bagging operator the ability to bag cuts of meat without lifting or otherwise handling the cuts. Further, the loading fork is capable of smoothly transferring bagged cuts to a take-away conveyor, thereby eliminating the need for manual repositioning and smoothing the bagged cut of meat on the take-away conveyor and reducing the number of bags damaged in the transfer process. Moreover, the present invention includes a sweep conveyor for pushing the bagged cut of meat from the loading fork onto the take-away conveyor.

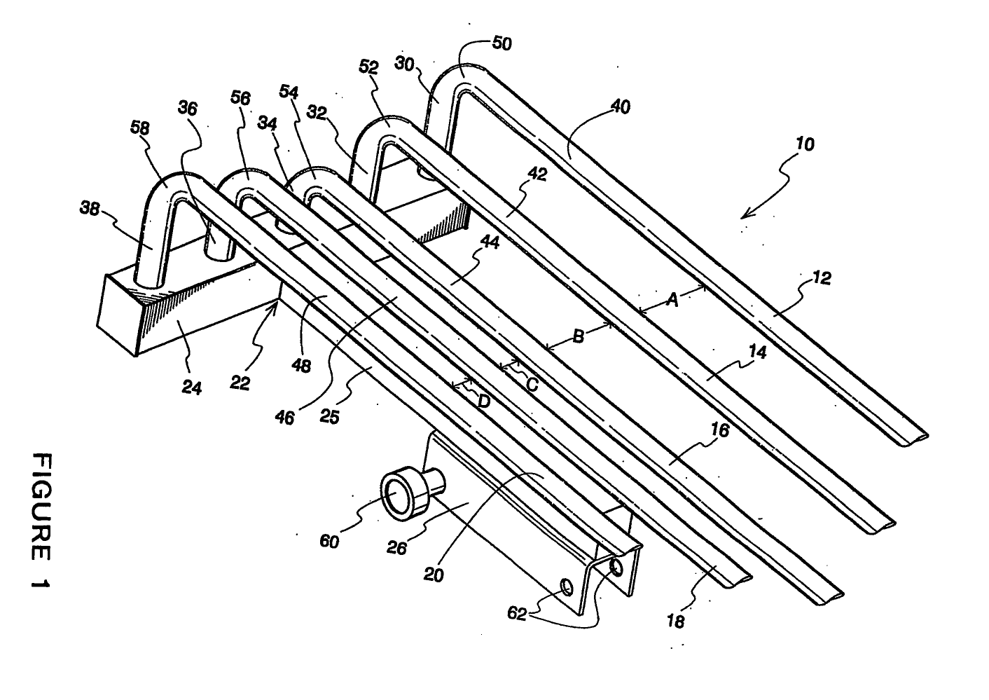

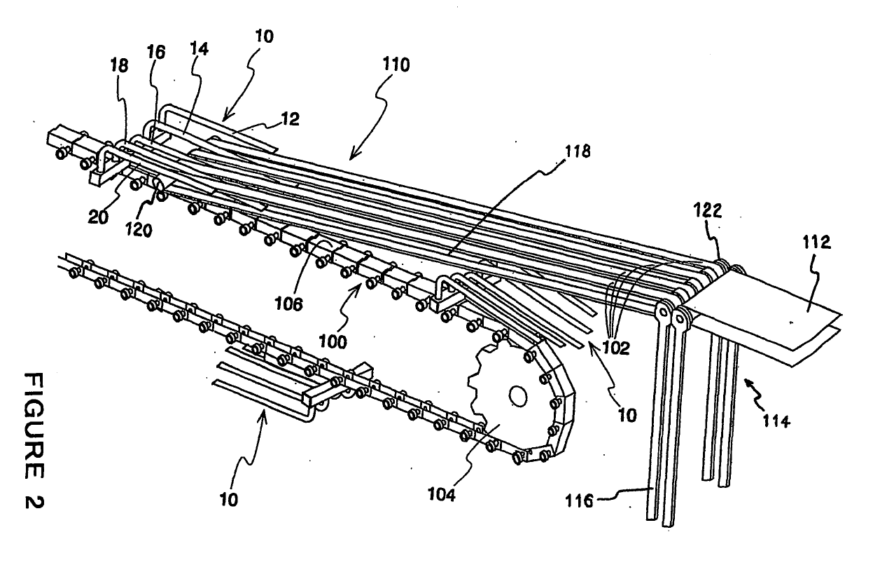

As shown in FIG. 1, a loading fork 10 has a plurality of fingers 12, 14, 16, 18, 20 directly attached to a carriage 22. The carriage 22 has a back portion 24 for attaching to the fingers 12, 14, 16, 18, and 20, a front portion 25 attached to the back portion 24 and extending in the same direction as the fingers 12, 14, 16, 18 and 20 and a mounting portion 26, attached to the front portion 25, for securing the loading fork 10 to a chain conveyor 100 (FIG. 2). Preferably, a hinge (not shown) is positioned on the back portion 24 allowing the back portion 24 and/or fingers 12, 14, 16, 18 and 20 to rise upwardly relative to the front portion 25. As described below, the upward extension of the fingers 12, 14, 16, 18 and 20 facilitates delivery of the meat from the fork 10 to a take-away conveyor 110 (FIG. 2).

In the embodiment of the invention illustrated in FIG. 1, the fork 10 has five individual fingers 12, 14, 16, 18, and 20. Each finger 12, 14, 16, 18, and 20 has a generally vertical portion 30, 32, 34, 36, and 38 and a generally horizontal portion 40, 42, 44, 46, and 48 joined by a transitional curved portion 50, 52, 54, 56, and 58. The generally vertical portion 30, 32, 34, 36, and 38 of each finger 12, 14, 16, 18, and 20 provides clearance from the underlying chain conveyor 100 (FIG. 2) allowing a bagging operator, or a machine, to bag a cut of meat without having to lift or otherwise handle the cut of meat itself. Collectively, the top surface of the generally horizontal portions 40, 42, 44, 46, and 48 of each finger 12, 14, 16, 18, and 20 provide a loading surface used to carry a cut of meat.

The generally vertical portion 30, 32, 34, 36, and 38 of each finger 12, 14, 16, 18, and 20 may vary in height so as to provide a loading surface better suited to carry a cut of meat. For example, in the embodiment of the present invention illustrated in FIG. 1, outer fingers 12 and 20 of the loading fork 10 have a greater vertical length than inner fingers 14 and 18. Likewise, the inner fingers 14 and 18 have a greater vertical length than the middle finger 16. The illustrated V-shaped configuration of the vertical lengths of the fingers 12, 14, 16, 18, and 20 provides an inwardly sloped loading surface that increases the stability of a cut of meat on the loading fork 10. Additionally, the vertical length of each finger 12, 14, 16, 18, and 20 may be otherwise configured to raise the generally horizontal sections 40, 42, 44, 46, and 48 above the carriage 22 in any manner apparent to one with ordinary skill in the art. For example, the vertical length of each finger 12, 14, 16, 18, and 20 may be configured at an angle less than forty-five degrees with respect to the carriage 22.

The length of the generally horizontal sections 40, 42, 44, 46, and 48 of each finger 12, 14, 16, 18, and 20 may vary in such a manner as to provide a loading surface better suited to carry a cut of meat. For example, as shown, the outer fingers 12 and 20 of the loading fork 10 have shorter horizontal lengths than the inner fingers 14 and 18. Likewise, the inner fingers 14 and 18 have shorter horizontal lengths than the middle finger 16. This specific configuration of horizontal lengths is designed to provide a loading surface capable of supporting longer narrower cuts of meat as well as shorter wider cuts of meat. As shown in FIG. 1, the horizontal portions 40, 42, 44, 46, and 48 are configured at a ninety-degree angle with respect to the vertical portions 30, 32, 34, 36, and 38. However, both horizontal portions 40, 42, 44, 46, and 48 and vertical portions 30, 32, 34, 36, and 38 may be curved, angled, or otherwise configured to effectively carry cuts of meat.

As shown in FIG. 1, each finger 12, 14, 16, 18, and 20 is directly attached to the carriage 24 such that there is a longitudinal space A, B, C, and D between each finger 12, 14, 16, 18, and 20 extending along the entire length of each finger 12, 14, 16, 18, and 20.

As shown in FIG. 1, the back portion 24 of the carriage 22 extends along the carriage's 22 width and provides a top surface for attaching the fingers 12, 14, 16, 18, and 20. The vertical portions 30, 32, 34, 36, and 38 of each finger 12, 14, 16, 18, and 20 attach to the top surface of the back portion 24 of the carriage 22. The configuration shown allows the horizontal portions 40, 42, 44, 46, and 48 of each finger 12, 14, 16, 18, and 20 to pass through a take-away conveyor 110 comprising a plurality of parallel aligned, narrow belts 102 without having the back portion 24 of the carriage 22, or any other portion of the carriage 22, come in contact with the belts 102. Alternatively, the fingers 12, 14, 16, 18, and 20 may be attached to the carriage 14 by any means so long as it still allows the fingers 12, 14, 16, 18 and 20 to pass through or around the belts 102.

The mounting portion 26 of the carriage 22 is secured to the chain conveyor 100. As shown in FIG. 1, a mounting screw 60 and eyelets 62 for a mounting pin are provided for securing the loading fork 10 to the chain conveyor 100. Alternatively, the carriage 22 may be mounted to the chain conveyor 100 by any suitable means known in the art.

Referring now to FIG. 2, a series of loading forks 10 is shown on a chain 106 traveling around a vertical chain sprocket wheel 104. The chain sprocket wheel 104, however, may be configured horizontally or in any other position that allows the loading fork 10 to continue along the chain conveyor 100 after it has cleared the belts 102. The take-away conveyor 110 is positioned near one end of the fork loader system such that the fingers 12, 14, 16, 18, and 20 of each loading fork 10 are aligned with the gaps between the belts 102 such that the fingers 12, 14, 16, 18, and 20 of the loading fork 10 can pass through the gaps between the belts 102. The take-away conveyor 110 transfers its load to a single belt conveyor 112 positioned at the downstream end of the take-away conveyor 110. The loading fork 10 and take-away conveyor 110 are configured such that at least two fingers 12 and 14 of the loading fork pass around at least one belt 102.

The four belts 102 of the take-away conveyor 110 are powered by a common driveshaft, slope upwards away from the loading forks 10, and operate at a faster speed than the chain 100 to which the loading forks 10 are secured. Each of the four belts 102 is supported by a support frame 114. The support frame 114 includes a generally vertical support member 116 and four cantilever support members 118. Each of the four cantilever support members 118 supports an individual, vertical roller 120 at the upstream end of the take-away conveyor 110. The generally vertical support member 116 supports the cantilever support members 118 and a driveshaft roller 122 powered by a motor (not shown) at the downstream end of the take-away conveyor 110. Each of the four belts 102 loops around the roller 120 at the upstream end and the driveshaft roller 122 at the downstream end. Each of the four belts 102 is driven by the driveshaft roller 122. The cantilever support members 118 and the individual rollers 120 are configured such that there is a gap between each of the four belts 102 for the fingers 12, 14, 16, 18, and 20 of the loading fork 10 to pass through.

The conveyor 110 can be configured so that it pivots about the driven end, thereby allowing the conveyor to “float.” This facilitates the passing of the fork 10 through the belts 102 in case any contact is made by the fork 10 after it has passed through the belts. Additionally, the conveyor 110 can be mounted to the support member as a unit by a quick release mechanism. This way, if a problem, such as a broken belt, occurs with the tale-away conveyor 110, the entire conveyor 110 can be quickly taken off and replaced with a new conveyor and operation can resume while the problematic conveyor is repaired offline, thereby minimizing the loss of processing time on the system.

The hinge (not shown) is provided to prevent the bag around the meat and the loading fork 10 from becoming damaged by the loading fork's 10 fingers 12, 14, 16, 18, and 20 when transferring meat from the loading fork 10 to the belts 102. The hinge allows the fingers 12, 14, 16, 18, and 20 of the loading fork 10 to raise slightly such that the loading fork 10 remains elevated above the height of the belts 102 until the belts 102 have removed the meat and bag from the loading fork 10. As the weight of the cut of meat is transferred to the belts 102, the upward motion of the bag pulls the hinge of the loading fork 10 open, allowing the hinged portion of the loading fork 10 to raise between approximately 1-1.5 inches. As the hinge opens, the four belts 102 pull the bagged cut of meat off of the loading fork 10 and transport the bagged cuts of meat onto a standard single take-away conveyor 112, which in turn transfers the bagged cuts of meat to a conveyor synchronized to a vacuum packing operation (not shown).

The belts 102 of the take-away conveyor 110 must operate at a speed sufficient to remove the bagged meat from the loading fork 10 before the fingers 12, 14, 16, 18, and 20 damage the bag by pulling the bag through the gaps between the belts 102. In other words, the belts 102 of the take-away conveyor 110 must operate at a speed sufficient to remove the bagged cut of meat from the loading fork 10 before the height of the belts 102 rises to an elevation greater than the height of the fingers 12, 14, 16, 18, and 20 as measured when the hinge is in its fully opened position. The minimum speed at which the belts of the take-away conveyor 110 must operate will vary depending upon the angle of the take-away conveyor 110 as well as the speed the loading fork 10 passes through the take-away conveyor 110. As the angle of the take-away conveyor 110 with respect to the loading fork 10 increases, the belts 102 of the take-away conveyor 110 must operate at a higher speed. Likewise, as the speed the loading fork 10 passes through the take-away conveyor 110 increases, the belts 102 of the take-away conveyor 110 must operate at a higher speed.

When the meat is completely off the fork 10, the hinge closes and the fork 10 is lowered to its initial position. Because each bag has been pulled over each cut of meat on the loading fork 10 by a bagging operator, the open end of the bag hangs smoothly behind the cut of meat as it is pulled from the loading fork 10. Alternatively, a loading horn (not shown) or a robotic arm (not shown) may bag the cut of meat. Additionally, the cut of meat can be bagged in any manner apparent to one with ordinary skill in the art.

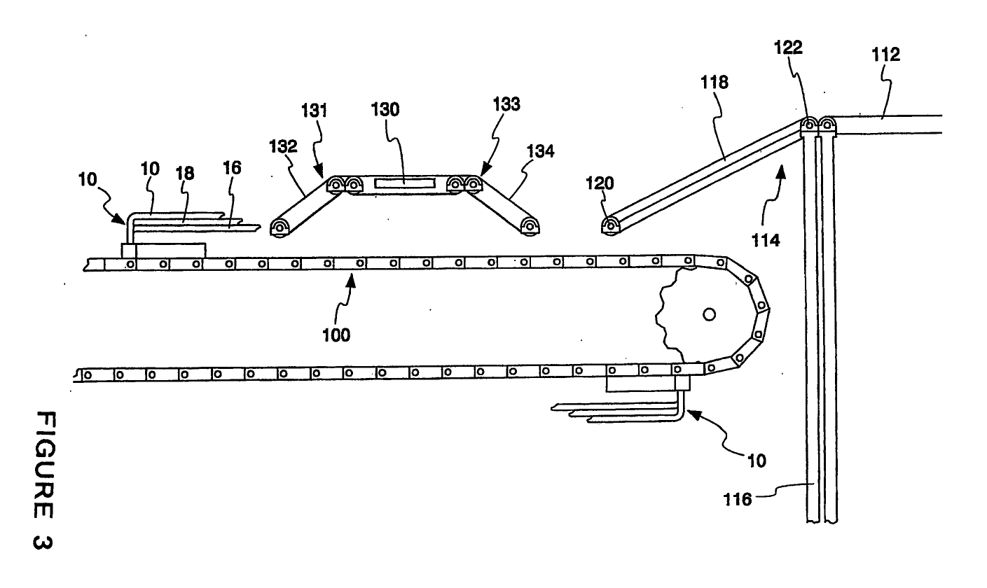

Referring now to FIG. 3, an in-line belt conveyor scale 130 can be incorporated into the fork loader system. As shown in FIG. 3, a take-away conveyor 131 comprising a plurality of parallel aligned, narrow belts 132 (similar to the take-away conveyor 110 and belts 102 described above) can be positioned above the chain conveyor 100 such that the fingers 12, 14, 16, 18, and 20 of the loading fork 10 pass through gaps between the belts 132. In one embodiment, the take-away conveyor rises at an angle of approximately five (5) degrees and is approximately one (1) meter long. The narrow belts 132 are inclined relative to the chain conveyor 100 to promote lifting a bagged or an unbagged cut of meat off the loading fork 10 onto the belts 132. Additionally, if the cut of meat has been bagged prior to arriving at the belts 132, as the fingers 12, 14, 16, 18, and 20 of the loading fork 10 begin to pass around each belt 132 and the bagged cut of meat makes contact with the belts 132, the hinge of the loading fork 10 is pulled open by the rising bag, raising the loading fork 10 between approximately 1-1.5 inches, allowing the meat to be on top of the narrow belt conveyors 132. If the cut of meat has been bagged prior to arriving at the belts 132, the belts 132 must operate at a speed sufficient to remove the cut of meat from the loading fork 10 before the fingers 12, 14, 16, 18, and 20 damage the bag by pulling the bag through the gaps between the belts 132. The minimum speed at which the belts 132 must operate will vary depending upon the angle of the belts 132, the speed the loading fork 10 passes through the belts 132, and whether the cut of meat is bagged or unbagged. The belts 132 must operate at a higher speed when the angle the belts 132 operate at with respect to the loading fork 10 increases, when the loading fork 10 passes through the take-away conveyor 131 at a greater speed, and when the cut of meat is bagged.

The belts 132 transport the cut of meat to the in-line belt conveyor scale 130. In one embodiment, the conveyor for the in-line belt conveyor scale 130 is approximately one (1) meter long. The in-line belt conveyor scale 130 weighs the cut of meat as it transports the cut to a delivery conveyor 133 comprising a plurality of parallel aligned, narrow belts 134 configured in a declined position (similar to the take-away conveyors 110 and 131 and belts 102 and 132 described above) to transfer the cut of meat back to the loading fork 10 from which it had been lifted. In one embodiment, the delivery conveyor is set at an angle of approximately five (5) degrees and is one (1) meter long as well, The two sets of belts 132 and 134 and the in-line belt conveyor scale 130, as a system, operate at a higher speed than the chain conveyor 110 allowing the cut of meat to traverse a greater linear distance than the loading fork 10 while maintaining synchronization with the loading fork 10. In addition to, or in lieu of, the in-line belt scale 130, a pickle injector, tenderizer, or other device apparent to one with skill in the art may be similarly incorporated into the fork loader system.

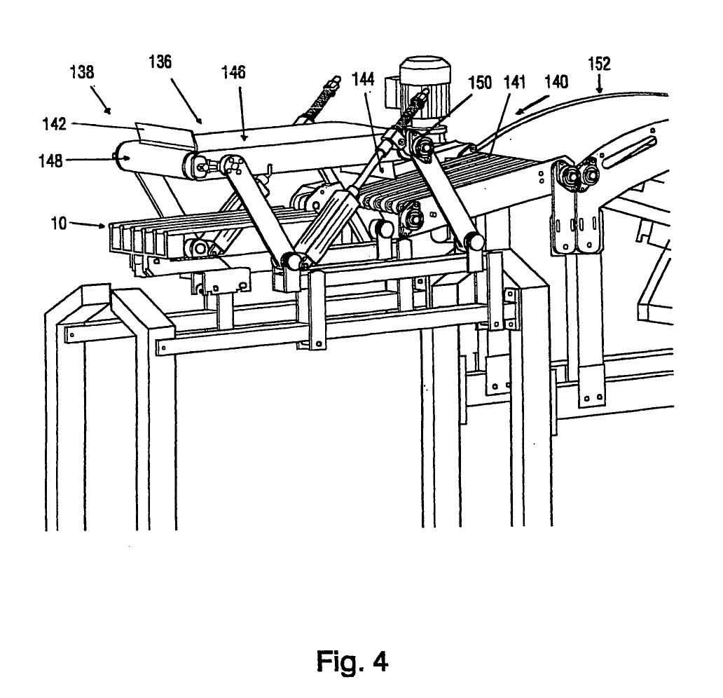

Referring now to FIG. 4, a sweeping conveyor 136 may be incorporated into a fork loader system 138 wherein loading forks 10 transfer loads, such as bagged cuts of meat, to a take-away conveyor 140. The fork loader system may include loading forks 10 mounted to a loading fork conveyor (not shown) to transfer loads to the take-away conveyor 140. The take-away conveyor 140 may include a plurality of parallel aligned narrow belts 141, as described above with respect to FIG. 2. The sweeping conveyor 136 may be included in the fork loader system 138 to assist the transfer of loads from the loading forks 10 to the take-away conveyor 140.

As shown in FIG. 4, the sweeping conveyor 136 includes a first paddle 142 and a second paddle 144 mounted equidistant from each other on a belt 146 that is mounted to a first end pulley 148 and a second end pulley 150. The end pulleys 148 and 150 are driven by a motor and drive shaft assembly (not shown). The sweeping conveyor 136 is located above the fork loader system 138, along the path of the loading forks 10, such that the paddles 142 and 144 pass over the loading forks 10 at a height that allows the paddles 142 and 144 to make contact with the loads carried by the loading forks 10. Alternatively, any number of paddles, mounted in any configuration, may be utilized to practice the present invention. Further, a chain and chain sprocket wheels, or any other similar conveyor mechanism, may be used in the place of the belt 146 and end pulleys 148 and 150.

The motor and drive shaft assembly drives the end pulleys 148 and 150 and causes the paddles 142 and 144 to travel faster than the loading forks 10 of the fork loader system 138. The movement of the loading forks 10 and the paddles 142 and 144 of the sweeping conveyor 136 is timed such that one of the paddles 142 and 144 passes over each of the loading forks 10 as each loading fork 10 transfers its load to the take-away conveyor 140 as described above with respect to FIG. 2. Consequently, the paddles 138 and 140 assist the transfer of the loads to the take-away conveyor 140 by pushing or sweeping the loads from the loading forks 10 onto the take-away conveyor 140. In one embodiment of the present invention it has been found that operating the sweeping conveyor 136 such that the paddles 138 and 140 travel approximately three times the speed of the loading forks 10 will provide effective assistance to the transfer of the loads from the loading forks 10 to the take-away conveyor 140 from where the loads are transferred to a further conveyor 152 for onward movement.

The sweeping conveyor 136 may be designed to operate continuously or, alternatively, the sweeping conveyor 136 may incorporate a photocell (not shown) for operating the sweeping conveyor 136 only when the photocell senses a load on the loading fork 10. For example, when using a photocell to trigger the operation of the sweeping conveyor 136, the paddles 142 and 144 may be located in a standby position until a load is sensed on one of the loading forks 10. For example, each paddle may be located at either end of the sweeping conveyor 136, extending from the end pulleys 148 and 150 in a horizontal direction, to allow the loading forks 10 and the loads to travel under the sweeping conveyor 136 without interference. When the photocell senses a load is being carried by the next loading fork 10 to pass through the take-away conveyor 140, the motor and drive shaft assembly is activated and one of the paddles 142 and 144 is swept across the top of the loading fork 10 as the loading fork 10 passes through the take-away conveyor 140. The sweeping conveyor 136 may then return to the standby position until the photocell senses another bagged cut of meat.

In the embodiment shown in FIG. 4, the paddles 142 and 144 are constructed from the rubberized material commonly used to manufacture conveyor belts. The width of the paddles 142 and 144 is approximately the same width as the loading forks 10, approximately 300 mm. Additionally, the height of the paddles 142 and 144 is approximately 150-200 mm.

Although the sweeping conveyor 136 is described above with respect to the fork loader system 138 including the plurality of parallel aligned narrow belts 141, the sweeping conveyor 136 may also be used in conjunction with a conventional take-away conveyor (not shown), such as conveyor 152. When using a conventional take-away conveyor, the fork loader system 138 would need to be reconfigured such that the loading forks 10 transfer their loads onto the conventional take-away conveyor as the loading forks 10 travel around the horizontal axis of the chain sprocket wheel of the loading fork conveyor. As each of the loading forks 10 travels around the chain sprocket wheel and tilts towards the conventional take-away conveyor, one of the paddles 142 and 144 of the sweeping conveyor 136 may pass over the loading fork 10 and sweep the load from the loading fork 10 to the conventional take-away conveyor. However, using the sweeping conveyor 136 in conjunction with the take-away conveyor 140 including the plurality of parallel aligned narrow belts 141, ensures a smoother transfer between the loading fork 10 and the take-away conveyor 140 and enables the fork loader system 138 to transfer bagged cuts of meat to the take-away conveyor 140 to be taken directly to a vacuum packing workstation (not shown) without having to manually adjust the bagged cut of meat on the take-away conveyor 140.

The loading fork 10 may be utilized in a method of transferring bagged or unbagged cuts of meat in a meat packing system. The method of the present invention allows a cut of meat to be smoothly transferred from a bagging operation to a take-away conveyor without requiring an operator to manually reposition and smooth the tail of the bag. The method of the present invention according to one aspect includes six primary steps. The first step includes providing a loading fork 10. The second step includes securing the loading fork 10 to a chain conveyor 100. The third step includes providing a plurality of parallel aligned, narrow belts 102. The fourth step includes loading a cut of meat onto the loading surface of a loading fork 10 or onto the narrow belts 102. The fifth step includes passing the fingers 12, 14, 16, 18, and 20 of the loading fork 10 around the belts 102, smoothly transferring the bagged cut of meat between the loading fork 10 and the narrow belts 102.

Additionally, the method of the present invention according to a further aspect may includes the optional step of pulling a bag over both the loading fork 10 and the loaded cut of meat. Further, the method of the present invention according to still further aspects may include sweeping the bagged cut of meat from said loading fork to said belt conveyors or a conventional take-away conveyor using a sweeping conveyor.

Where in the foregoing description, reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope or spirit of the invention as defined in the appended claims.

I claim:

1. A loading fork for use in a chain conveyor system including:
a carriage, said carriage bring mountable to a chain conveyor; and
at least one finger mounted to the carriage, said finger including a first portion that extends above the carriage and a second, generally horizontal portion, wherein said second portion of said finger is located above said carriage.

2. The loading fork of claim 1 further including a plurality of fingers with longitudinal space between adjacent fingers.

3. The loading fork of claim 2 wherein the plurality of fingers further includes at least five fingers, said second portion of said fingers vertically positioned to provide a generally V-shaped loading surface.

4. The loading fork of claim 2 wherein said carriage has a back portion and a mounting portion, said back portion and said mounting portion being coupled by a hinge.

5. The loading fork of claim 4 wherein said fingers are mounted to said back portion.

6. A system for transferring an object between a loading fork and a take-away conveyor including:
a loading fork conveyor having at least one loading fork mounted thereto;
a take-away conveyor positioned such that an object can be transferred from said loading fork to said take-away conveyor; and
a sweeping conveyor positioned adjacent said loading fork conveyor, said sweeping conveyor having at least one paddle mounted thereto such that said paddle is located above said loading fork and can push an object from said loading fork onto said take-away conveyor.

7. The system of claim 6 wherein said sweeping conveyer includes:
a chain mounted on a pair of sprocket wheels, said paddle being mounted to said chain; and,
a motor and drive shaft assembly coupled to one of said chain sprocket wheels for operating said sweeping conveyor

8. The system of claim 7 further including a photocell coupled to said motor and drive shaft assembly for controlling the operation of said sweeping conveyor.

9. The system of claim 7 wherein the take-away conveyor includes a plurality of parallel aligned, narrow belts with longitudinal space between adjacent belts.

10. The system of claim 8 wherein the plurality of parallel aligned, narrow belts further include:
an in-line process station;
a first belt conveyor positioned to transfer an object from said loading fork to said process station; and
a second belt conveyor positioned to transfer the object from said process station to said loading fork, wherein said first and second belt conveyors operate at a speed such that the object and said loading fork remain synchronized for transferring the object between the belt conveyors and said loading fork.

11. The system of claim 10 wherein the in-line process station is an in-line belt scale.

12. The system of claim 6 wherein the object is a cut of meat.

13. A system for transferring an object between a loading fork and a conveyor including:
a chain conveyor;
a loading fork having one or more fingers, said loading fork mounted to said chain conveyor; and
a plurality of parallel aligned, narrow belt conveyors positioned such that said one or more fingers can pass between said belt conveyors to transfer the object between said loading fork and said belt conveyors.

14. The system of claim 13 wherein the plurality of parallel aligned, narrow belts are take-away conveyors positioned to transfer an object from said loading fork to said belts.

15. The system of claim 13 wherein the plurality of parallel aligned, narrow belts are infeed conveyors positioned to transfer an object from said belts to said loading fork.

16. The system of claim 13 further including a sweeping conveyor positioned above said chain conveyor for sweeping the loaded object from said loading fork to said belt conveyors, said sweeping conveyor including:
a chain mounted on a pair of chain sprocket wheels;
a paddle mounted to said chain; and
a motor and drive shaft assembly coupled to one of said chain sprocket wheels for operating said sweeping conveyor.

17. The system of claim 16 further including a photocell coupled to said motor and drive shaft assembly for controlling the operation of said sweeping conveyor.

18. The system of claim 13 wherein the object is a cut of meat.

19. A loading fork for use in a chain conveyor system substantially as herein described with reference to FIGS. 1 to 3 or FIG. 4 of the accompanying drawings.

20. A system for transferring an object between a loading fork and a take-away conveyor substantially as herein described with reference to FIGS. 1 to 3 or FIG. 4 of the accompanying drawings.
